(19) United States
(12) Patent Application Publication
(10) Pub. No.: US 2010/0154191 A1
(43) Pub. Date: Jun. 24, 2010

(54) Wall Mount System

(75) Inventor: David F. Fowler, Hendersonville, NC (US)

Correspondence Address: BROUSE MCDOWELL LPA, 388 SOUTH MAIN STREET, SUITE 500, AKRON, OH, 44311, US

(73) Assignee: Spartanburg Steel Products, Inc., Spartanburg, SC (US)

(21) Appl. No.: 12/642,900

(22) Filed: Dec. 21, 2009

Related U.S. Application Data
(60) Provisional application No. 61/139,003, filed on Dec. 19, 2008.
(60) Provisional application No. 61/159,219, filed on Mar. 11, 2009.

(51) Int. Cl. B23P 11/00; A47F 5/08

(52) U.S. Cl. 29/428; 248/231.91; 248/226.11; 248/225.11

(57) ABSTRACT

Provided is a wall mount system that may comprise a wall bracket and an object bracket selectively connectable to the wall bracket. A wall bracket may comprise a wall plate and a first elongated shank. A first elongated shank may comprise an engagement surface adapted to support a first counter-engagement surface. An object bracket may comprise an object plate, a first counter-engagement surface integral to the object plate, and a feature adapted to engage and support an associated object to be mounted. An object plate may comprise a first object plate surface, a second object plate surface facing opposite to and away from the first object plate surface, and a first through hole connecting the first object plate surface with the second object plate surface. The first through hole may be adapted to permit insertion of the first elongated shank into the first through hole.

This application claims priority to U.S. Ser. No. 61/159,219, titled WALL MOUNT SYSTEM, filed Mar. 11, 2009, which is incorporated herein by reference, and to U.S. Ser. No. 61/139,003, titled WALL MOUNT SYSTEM, filed Dec. 19, 2008, which is incorporated herein by reference.

### TECHNICAL FIELD

Provided is a wall mount system. More particularly, provided is a system adapted to removably attach objects to walls.

### BACKGROUND

It is often desirable to mount or attach objects to walls for display or storage.

Objects desirable to mount to walls may comprise trophies, mirrors, paintings, pictures, sculptures, televisions, speakers, signs, diplomas, certificates, or other objects. Given the broad variety of objects desirable to mount to walls the characteristics of the objects relevant to mounting, such as the weight, thickness, other dimensions, and other variables of the objects are difficult to predict.

Trophies, such as fish, antlers, animals, animal heads, and other trophies, can vary enormously and present a large number of variables important to proper mounting. For example, a trophy may weigh anywhere from a few pounds to more than hundred pounds. Mounting a very heavy trophy on a wall securely requires very strong mounting hardware. This is especially important given that many trophies are mounted in an eccentric or cantilevered manner with the center of gravity substantially displaced from the region to which the mount is engaged. A trophy may be mounted on a wide variety of backings and boards used to secure the trophy for display. These backings and boards may vary in thickness, strength, and otherwise. Mounting hardware that relies on penetration of or similar engagement with backings or boards are subject to pull-out or similar failures due to the relevant properties of the backings or boards. Further, it is common for the skin or hide or a trophy animal to be pulled over a backing and board to conceal the periphery of the skin or hide. Large or bulky mounting hardware can create an obstruction to flush mounting or otherwise make it difficult to conceal the back of the trophy or the mounting hardware itself.

Conventional mounting hardware is poorly adapted for mounting a wide variety of trophies and other objects of differing weight, thickness, and other dimensions, in a manner that is secure, resilient, easy-to-use, and mounts in close proximity to the wall.

It remains desirable to provide a simple system capable of removably attaching a wide-variety of objects to walls.

### SUMMARY

Provided is a wall mount system that may comprise a wall bracket and an object bracket selectively connectable to the wall bracket. A wall bracket may comprise a wall plate and a first elongated shank. A first elongated shank may comprise an engagement surface adapted to support a first counter-engagement surface. An object bracket may comprise an object plate, a first counter-engagement surface integral to the object plate, and a feature adapted to engage and support an associated object to be mounted. An object plate may comprise a first object plate surface, a second object plate surface facing opposite to and away from the first object plate surface, and a first through hole connecting the first object plate surface with the second object plate surface. The first through hole may be adapted to permit insertion of the first elongated shank into the first through hole.

Further provided is a wall mount system that may comprise a wall bracket and an object bracket selectively connectable to the wall bracket. A wall bracket may comprise a wall plate and a first elongated shank that may comprise a first plurality of engagement surfaces adapted to engage a first counter-engagement surface and a second-counter engagement surface. A wall plate may comprise a first wall plate surface, a second wall plate surface facing substantially opposite to and away from the first wall plate surface, and a first hole through the wall plate. An object bracket may comprise an object plate, a support surface integrally connected to the object plate and adapted to support an associated object to be mounted, and a capture surface. An object plate may comprise a first object plate surface, a second object plate surface facing opposite to and away from the first object plate surface, and a first through hole connecting the first object plate surface with the second object plate surface. The first through hole may be adapted to permit insertion of the first elongated shank into the first through hole. The first through hole may comprise a first counter-engagement surface. The second object plate surface may comprise a second counter-engagement surface. A capture surface may be integrally connected to the object plate, and may have a facing substantially perpendicular to the support surface.

Further provided is a wall mount system that may comprise a steel wall bracket, and a steel object bracket selectively connectable to the wall bracket, wherein the wall mount system is adapted to mount a trophy. A steel wall bracket may comprise a wall plate, a first elongated shank, and a strengthening protrusion, rib, or flange integrally connected to the wall bracket. A wall plate may comprise a first wall plate surface, a second wall plate surface facing substantially opposite to and away from the first wall plate surface, a first hole through the wall plate, and a second hole through the wall plate. A first elongated shank may comprise a first plurality of engagement surfaces arranged in a stair-step or terrace-form and an engagement protrusion. The first plurality of engagement surfaces may be adapted to engage a first counter-engagement surface and a second-counter engagement surface. An object bracket may comprise an object plate, a first through hole adapted to permit insertion of the first elongated shank, a support surface integrally connected to the object plate and adapted to support an associated object to be mounted, and a capture surface. An object plate may comprise a first object plate surface and a second object plate surface facing opposite to and away from the first object plate surface. The second object plate surface may comprise a second counter-engagement surface. A first through hole may comprise a first counter-engagement surface and an engagement protrusion gap. A capture surface may be integrally connected to the object plate and may have a facing substantially perpendicular to the support surface.

Further provided is a method for mounting an object to be mounted. The method may comprise providing a wall bracket, engaging the wall bracket with a wall, providing an object bracket, engaging an associated object to be mounted to the object bracket, and engaging the object bracket with the wall bracket. A wall bracket may comprise a wall plate and a first elongated shank comprising a first plurality of engagement surfaces. A first plurality of engagement surfaces may be adapted to engage a first counter-engagement surface and a second-counter engagement surface. An object bracket may be selectively connectable to a wall bracket. An object bracket may comprise an object plate, a support surface integrally connected to the object plate and adapted to support an associated object to be mounted, and a capture surface. An object plate may comprise a first object plate surface, a second object plate surface facing opposite to and away from the first object plate surface, a first through hole connecting the first object plate surface with the second object plate surface. The first through hole may be adapted to permit insertion of the first elongated shank into the first through hole. The first through hole may comprise a first counter-engagement surface. The second object plate surface may comprise a second counter-engagement surface. A capture surface may be integrally connected to the object plate and may have a facing substantially perpendicular to the support surface.

Another object of the present invention is to provide a wall mount system that is cost-effective to manufacture and easy to use.

### BRIEF DESCRIPTION OF THE DRAWINGS

FIG. 1 is a front view of an embodiment of an object bracket.

FIG. 2 is a side view of an embodiment of an object bracket.

FIG. 3 is a front view of an embodiment of a wall bracket.

FIG. 4 is a side view of an embodiment of a wall bracket.

FIG. 5 is a perspective view of an embodiment of an object bracket.

FIG. 6 is a front view of an embodiment of an object bracket.

FIG. 7 is a perspective view of an embodiment of an wall bracket.

FIG. 8 is a front view of an embodiment of a wall bracket.

FIG. 9 is a view of an embodiment of an object bracket engaged with an embodiment of an object to mount.

FIG. 10 is a view of an embodiment of an object to mount.

FIG. 11 is a perspective view of an embodiment of an wall bracket.

FIG. 12 is a view of an embodiment of a wall bracket and an embodiment of an object bracket engaged with an embodiment of an object to mount.

FIG. 13 is another view of an embodiment of a wall bracket and an embodiment of an object bracket engaged with an embodiment of an object to mount.

FIG. 14 is a partial sectional side view of an embodiment of a wall bracket engaged with an embodiment of a wall.

FIG. 15 is a front view of an embodiment of a wall bracket.

FIG. 16 is a partial sectional side view of an embodiment of a wall, an embodiment of a wall bracket, and an embodiment of an object bracket engaged with an embodiment of an object to mount.

FIG. 17 is a partial sectional side view of an embodiment of a wall, an embodiment of a wall bracket, and an embodiment of an object bracket.

FIG. 18 is a partial sectional side view of an embodiment of a wall bracket, and an embodiment of an object bracket engaged with an embodiment of an object to mount.

FIG. 19 shows another embodiment of a wall mount system.

FIG. 20 is a perspective view of another embodiment of an object bracket.

FIG. 21 is a side view of an embodiment of an object bracket.

FIG. 22 is a perspective view of another embodiment of an object bracket.

FIG. 23 is a front view of an embodiment of an object bracket.

FIG. 24 is a front view of another embodiment of an object bracket.

### DETAILED DESCRIPTION

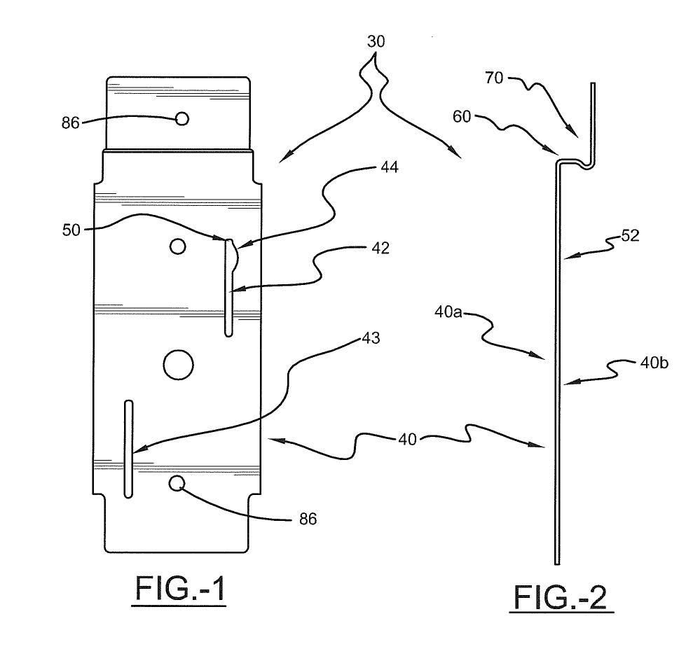

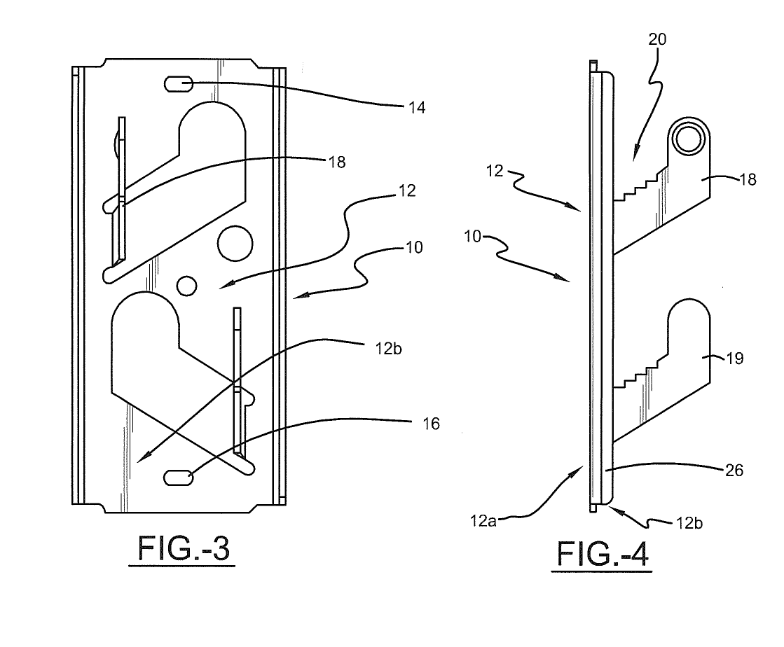

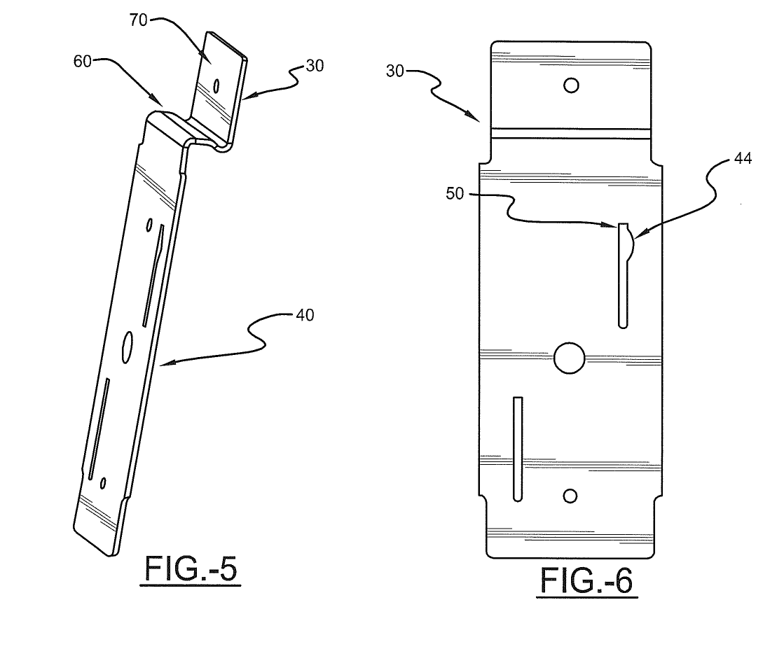

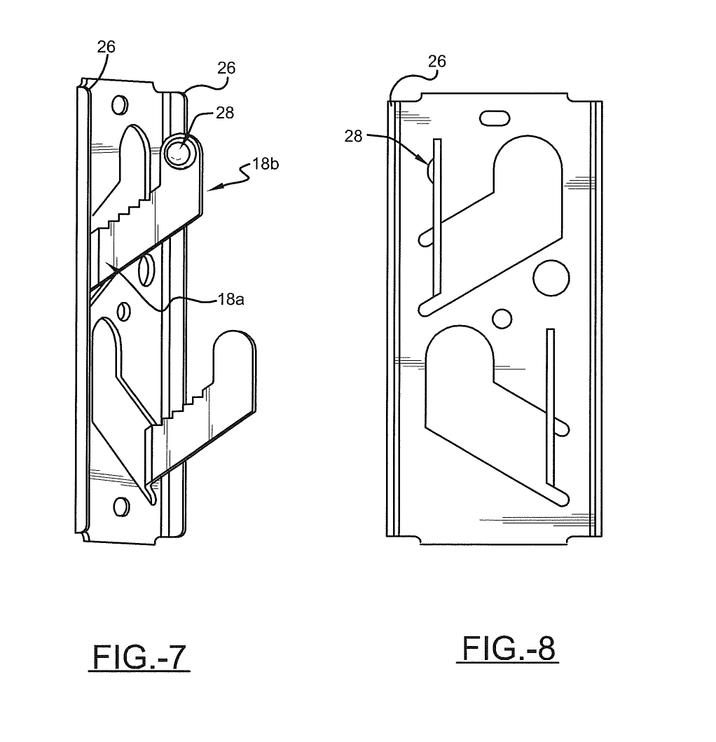

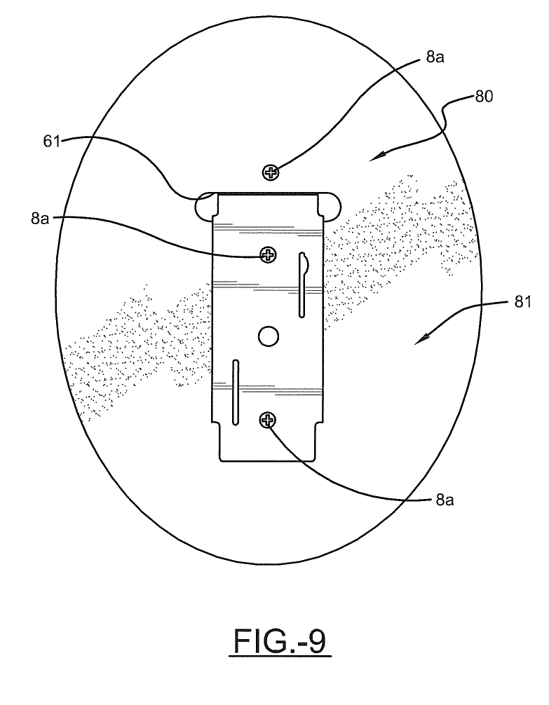

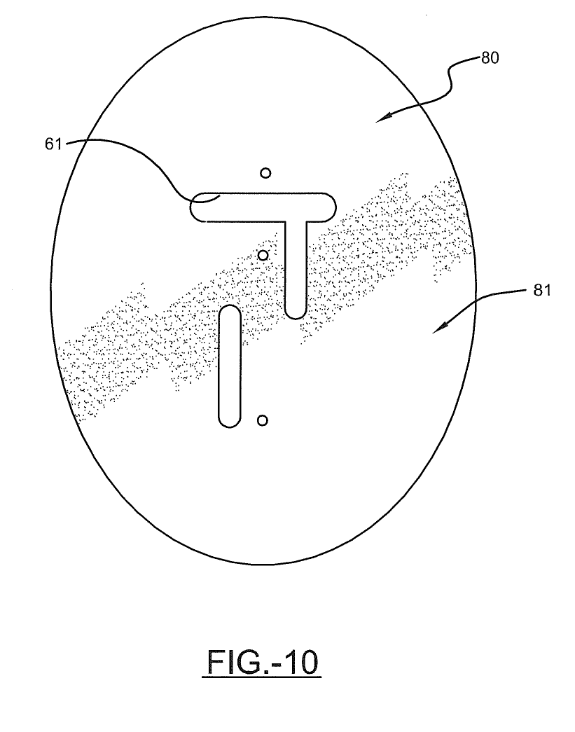

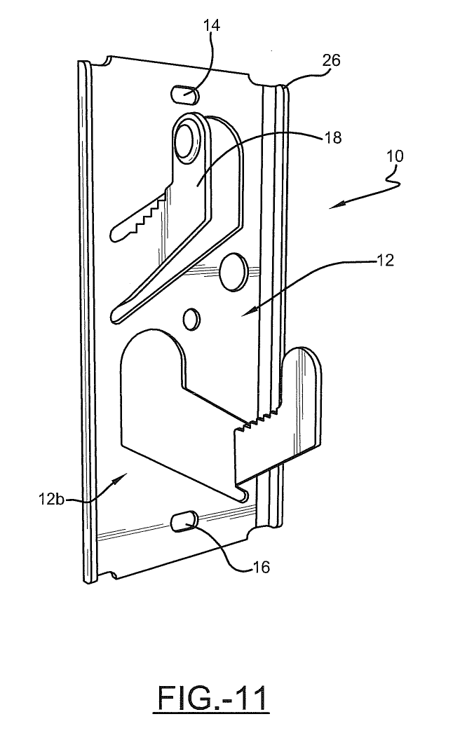

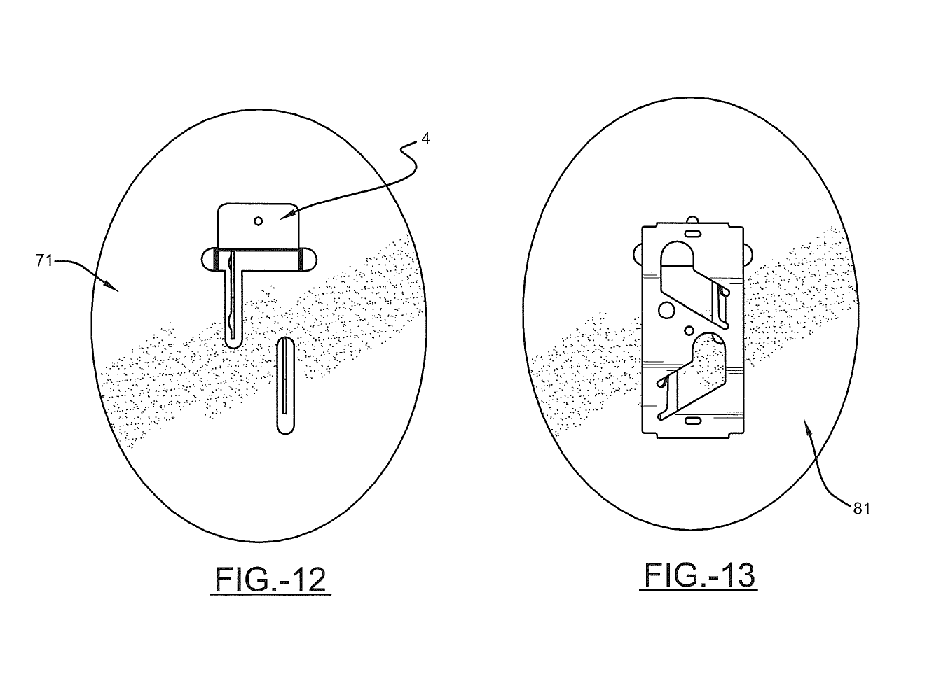

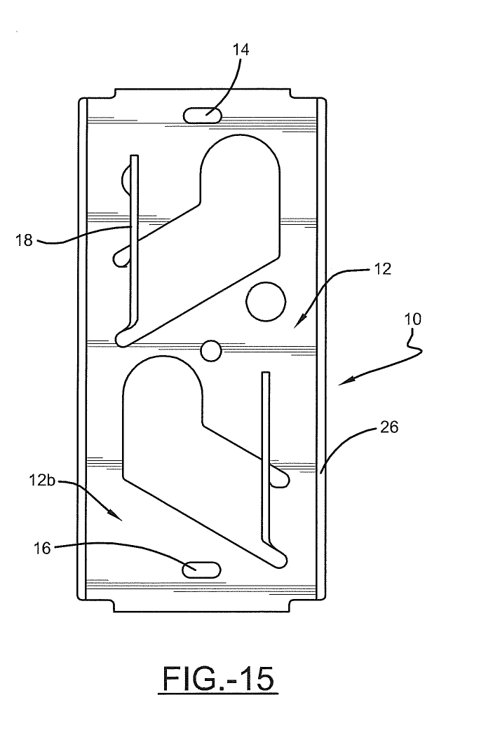

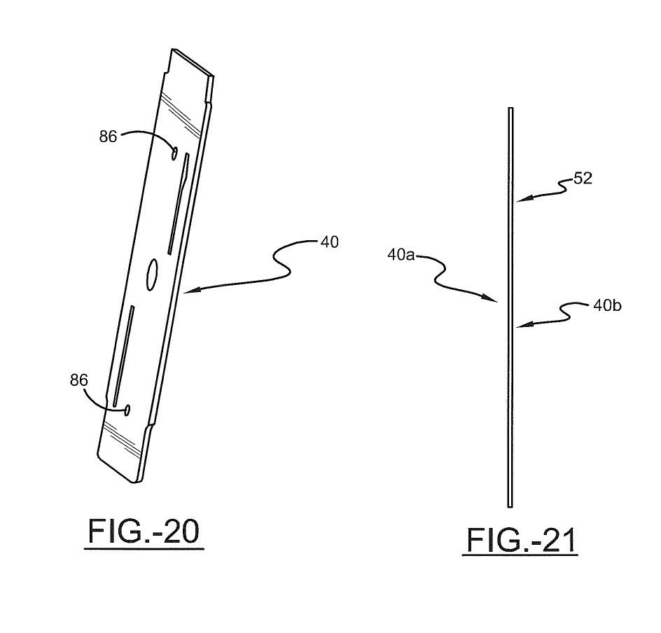

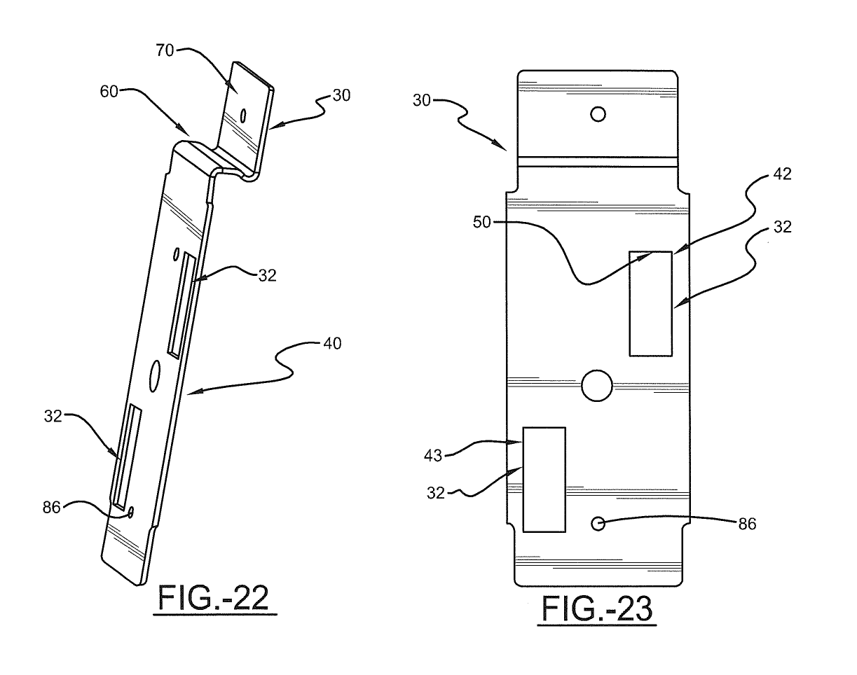

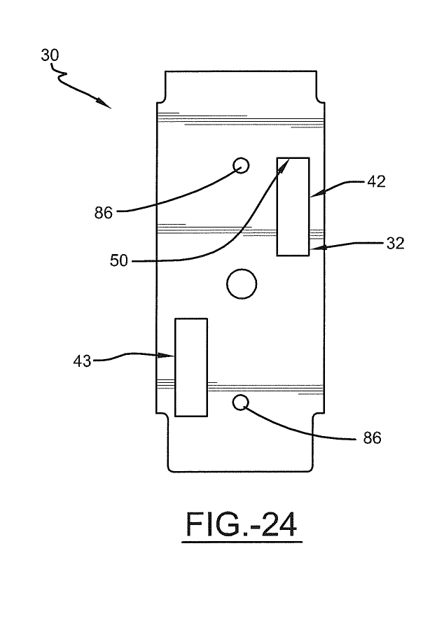

Reference will be made to the drawings, FIGS. 1-24, wherein the showings are only for purposes of illustrating certain embodiments of a wall mount system, and not for purposes of limiting the same.

As used herein, facing directions of surfaces may be described as having the same facing, opposite facing, perpendicular facing, oblique facing, some facing substantially similar to a described facing, or some other facing. Surfaces with opposite facing can be situated to face one another or to face away from one another. For illustration purposes only, and without limitation, surfaces 40a and 40b are surfaces with opposite facing that face away from one another; surfaces 60 and 70 are surfaces with perpendicular facing to one another; surfaces 70 and 40a are surfaces having the same facing; and surfaces 70 and 40b are surfaces with opposite facing that face toward one another.

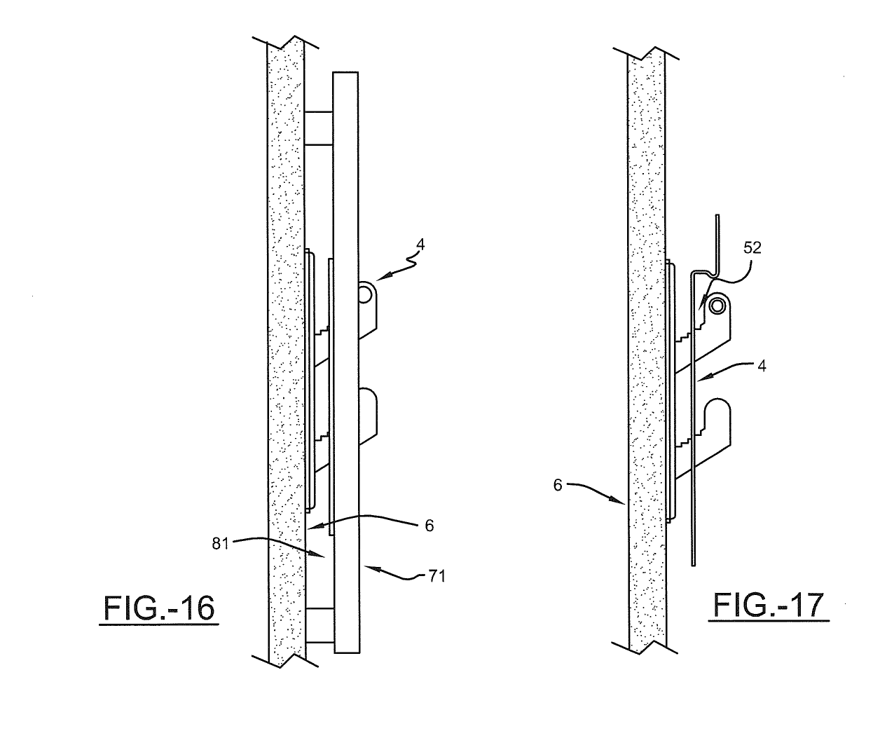

As used herein, unless otherwise noted, the term “wall” will refer to any surface to which an object to be mounted may be secured with the wall mount system. Without limitation, a wall may comprise an interior wall, an exterior wall, a column, a stud, a pillar, a door, a beam, a joist, or a ceiling. In certain embodiments, a wall may be substantially planar. For illustration purposes only, and without limitation, a wall 6 is shown is FIGS. 16 and 17.

As used herein, unless otherwise noted, the phrase “object to be mounted” may refer to any object for which mounting to a wall is desirable. Without limitation, an object to be mounted may comprise a trophy, a mirror, a painting, a picture, a sculpture, a television, a speaker, a sign, a diploma, or a certificate. The object to be mounted may also include trophies comprising animals or parts of animals taken during hunting activities.

With reference to FIGS. 1-24, non-limiting embodiments of the wall mount system are shown. A wall mount system 4 may comprise a wall bracket 10 and an object bracket 30. The wall bracket 10 comprises a wall plate 12, a first hole 14, a second hole 16 and a first elongated shank 18. Without limitation, the wall bracket 10 may comprise metal, plastic, or other engineering materials. Without limitation, the wall bracket 10 may comprise iron, iron alloys, steel, stainless steel, aluminum, aluminum alloys, copper, copper alloys, bronze, brass, or combinations thereof. In certain embodiments, and without limitation, the wall bracket 10 comprises a high strength low alloy steel. In certain embodiments, and without limitation, the wall bracket 10 comprises a hot rolled, pickled, oiled high strength, low alloy, 50 ksi minimum yield steel.

The wall plate 12 comprises a component adapted for engagement with a wall 6 and with an object plate 40 to be described below. In certain embodiments, and without limitation, the wall plate 12 may comprise a plate, a strap, or a block. In certain embodiments, the wall plate 12 comprises one or more surfaces adapted to engage the wall 6. In certain embodiments the wall plate 12 comprises a first wall plate surface 12a and a second wall plate surface 12b. In certain embodiments the first wall plate surface 12a will have a facing opposite to and away from that of the second wall plate surface 12b.

The wall bracket 10 may comprise a first hole 14 though which mechanical fasteners 8 may be at least partially inserted in order to removably or fixedly secure the wall plate 12 to the wall 6 with which it is to be engaged. In certain embodiments the wall bracket 10 may further comprise a second hole 16 though which mechanical fasteners 8 may be at least partially inserted in order to removably or fixedly secure the wall plate 12 to the wall 6 with which it is to be engaged.

Without limitation, first hole 14, or second hole 16, may comprise one or more of the features of a threaded hole, a clearance hole, an interference fit hole, a slotted hole, a round hole, a chamfered hole, a filleted hole, a counterbored hole, or a countersunk hole. Without limitation, in certain embodiments, the first hole is a round, clearance, chamfered hole, and the second hole is a slotted hole. In certain embodiments, and without limitation, first hole 14 or second hole 16 slotted to permit adjustment of the position of the wall plate 12 with respect to a mechanical fastener 8.

Without limitation, the mechanical fastener 8 may comprise any suitable type of fastener. Without limitation, the mechanical fastener 8 may comprise bolts, screws, nails, rivets, pins, staples, clips, clamps, or rods.

The first elongated shank 18 may comprises an engagement surface 20 and an engagement protrusion 28. In certain embodiments, the elongated shank 18 comprises a proximate end 18a engaged to a wall plate 12 and a distal end 18b extending from wall plate 12. The first elongated shank 18 comprises adaptations to permit engagement with the object bracket 30, and removable insertion of a least a portion of the first elongated shank 18 into a feature of the object bracket 30. This feature is described in greater detail below.

The engagement surface 20 may comprise a plurality surfaces adapted to engage with one or more features of the object bracket 30. In certain embodiments, the engagement surfaces 20 comprise a first set of engagement surfaces 22 each facing in a substantially similar first direction. In certain embodiments, the engagement surfaces 20 comprise a first set of engagement surfaces 22, with each member of the first set of engagement surfaces facing in a substantially similar first direction, and a second set of engagement surfaces 24, with each member of the second set of engagement surfaces facing in a substantially similar second direction. In certain embodiments, the first set of engagement surfaces 22 are offset from one another in a third direction or in more directions. In certain embodiments, the second set of engagement surfaces 24 are offset from one another in a fourth direction or in more directions.

The first direction may be any direction, including, but not limited to, substantially the same direction as that of the facing direction of the first wall plate surface 12a, substantially opposite that of the facing direction of the first wall plate surface 12a, substantially perpendicular to the facing direction of the first wall plate surface 12a, oblique to the facing direction of the first wall plate surface 12a, substantially the same direction as that of the facing direction of the second wall plate surface 12b, substantially opposite that of the facing direction of the second wall plate surface 12b, substantially perpendicular to the facing direction of the second wall plate surface 12b, or oblique to the facing direction of the second wall plate surface 12b. The third direction may be substantially the same as the first direction, substantially perpendicular to the first direction, substantially opposite to the first direction, or oblique to the first direction.

The second direction may be substantially the same as the first direction, substantially perpendicular to the first direction, substantially opposite to the first direction, or oblique to the first direction. The fourth direction may be substantially the same as the second direction, substantially perpendicular to the second direction, substantially opposite to the second direction, or oblique to the second direction.

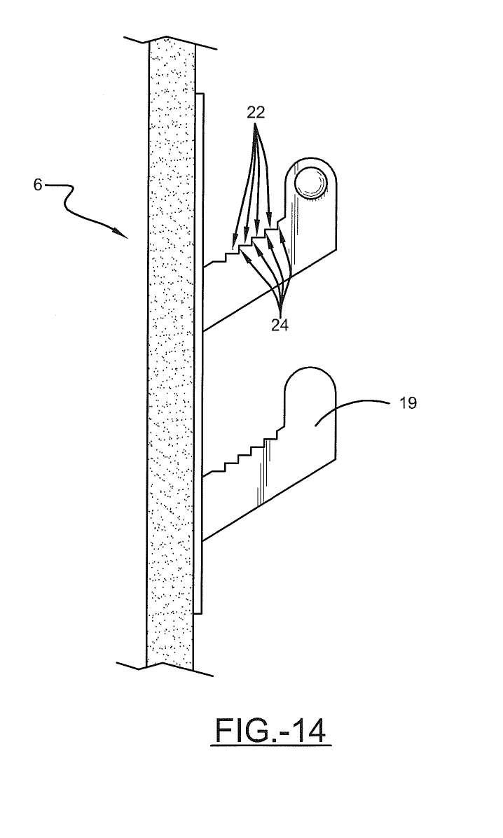

Without limitation, in certain embodiments, the first set of engagement surfaces 22 and the second set of engagement surfaces 24 are arranged in a stair-step or terrace-form as shown in at least FIG. 4 and FIG. 14 such that the first direction is substantially perpendicular to the second direction. In certain embodiments, the first set of engagement surfaces 22 are offset from one another both along a third direction parallel to the first direction and along a fourth direction parallel to the second direction. In certain embodiments, the second set of engagement surfaces 24 are offset from one another both along a third direction parallel to the first direction and along a fourth direction parallel to the second direction.

In certain embodiments, the first direction may be substantially parallel to a fourth direction, and the second direction may be substantially parallel to the third direction. In certain embodiments, at least some of the engagement surfaces 20 are substantially upwardly facing.

An engagement protrusion 28 comprises a protrusion extending from the first elongated shank 18. In certain embodiments, the engagement protrusion 28 protrudes in a direction perpendicular to the axis of elongation of the first elongated shank 18. In certain embodiments, the engagement protrusion 28 differentiates the geometry of the first elongated shank 18 from that of a second elongated shank 19. Without limitation, in certain embodiments, the presence of the engagement protrusion 28 prevents the first elongated shank 18 from being inserted into features of the object bracket 30 other than a feature designed to receive the first elongated shank 18 and, thereby prevents mistakes in engagement of the wall bracket 10 with the object bracket 30. Accordingly, in some embodiments, the engagement protrusion 28 functions as a kind of mistake-proof feature.

An object bracket 30 comprises an object plate 40 and a first counter-engagement surface 50. In certain embodiments, an object bracket 30 may comprise an object plate 40, a first counter-engagement surface 50, a support surface 60, and a capture surface 70.

In certain embodiments, and without limitation, an object plate 40 may comprise a plate, a strap, or a block. In certain embodiments, the object plate 40 comprises one or more surfaces adapted to engage the wall plate 12 and one or more surfaces adapted to engage an object to be mounted 80. In certain embodiments, the object plate 40 may comprise a first counter-engagement surface 50 adapted for engagement with the wall plate 12, the support surface 60 adapted for engagement with the object to be mounted 80, and the capture surface 70 adapted for engagement with the object to be mounted 80. In certain embodiments the object plate 40 comprises a first object plate surface 40a adapted to engage the wall plate 12 and a second object plate surface 40b adapted to engage the object to be mounted 80. In certain embodiments, the first object plate surface 40a will have a facing substantially opposite to and away from that of the second object plate surface 40b. In certain embodiments, the second object plate surface 40b will have a facing opposite to and toward that of the capture surface 70.

In certain embodiments the object plate 40 may comprise one or more through holes 86 though which mechanical fasteners 8 may be at least partially inserted in order to removably or fixedly secure the object plate 40 to the object to be mounted 80. It should be understood that any hole pattern chosen in accordance with sound engineering judgment may be utilized to receive fasteners.

In certain embodiments, the mechanical fastener 8 is adapted to provide a vertical reaction force to support the object to be mounted 80 against vertical forces acting on the object to be mounted 80. Vertical forces acting on the object to be mounted 80 may include gravitational forces, dynamic or inertial forces from acceleration of the object to be mounted 80, or impact forces. A vertical reaction force may be produced in response to a force acting in any direction of action that includes a vertical component. In certain embodiments, the mechanical fastener 8 is adapted to be sufficiently strong to provide enough upward support to support the object to be mounted 80 against downward forces without contribution from additional supporting elements.

In certain embodiments, the mechanical fastener 8 is adapted to provide a horizontal reaction force to support the object to be mounted 80 against horizontal forces acting on the object to be mounted 80. Horizontal forces acting on the object to be mounted 80 may include dynamic or inertial forces from acceleration of an object to be mounted 80, or impact forces. A horizontal reaction force may be produced in response to a force acting in any direction of action that includes a horizontal component.

Without limitation, the hole 86 may comprise one or more of the features of a threaded hole, a clearance hole, an interference fit hole, a slotted hole, a round hole, a chamfered hole, a filleted hole, a counterbored hole, or a countersunk hole.

Without limitation, the mechanical fasteners 8 may comprise any suitable type of fastener. Without limitation, the mechanical fasteners 8 may comprise bolts, screws, nails, rivets, pins, staples, clips, clamps, or rods. A first counter-engagement surface 50 comprises a surface adapted for engagement with the engagement surface 20. The counter-engagement surface 50 and the engagement surface 20 with which it is adapted to engage generally comprise surfaces with substantially opposite facings. Without limitation, in those certain embodiments in which the first counter-engagement surface 50 has a substantially downward facing when installed and the engagement surface 20 with which it is adapted to engage has a substantially upward facing when installed, the engagement surface may be adapted to provide an upward reaction force sufficient to support the object bracket 30 and the object to be mounted 80.

In certain embodiments, the object plate 40 may comprise a first shank receptacle hole 42 adapted to accept the first elongated shank 18 inserted therein. Without limitation, in certain embodiments, the first counter-engagement surface 50 is one of the surfaces defining a first shank receptacle hole 42 in the object plate 40. In certain embodiments, the first shank receptacle hole 42 may be elongated or otherwise adapted to provide resistance to rotation of the first elongated shank 18 inserted therein. The first shank receptacle hole 42 may be formed in the object plate 40 by drilling, punching, stamping, cutting, casting, or other known forming processes. In certain embodiments, the object plate 40 may comprise a second counter-engagement surface 52 in addition to the first counter-engagement surface 50. The second counter-engagement surface 52 may be adapted to engage the engagement surface 20. In certain embodiments the second counter-engagement surface 52 is part of second object plate surface 40b. In certain embodiments and without limitation, counter-engagement surface 52 is oblique to or substantially perpendicular to the first counter-engagement surface 50. In certain embodiments and without limitation, counter-engagement surface 52 is adapted to engage the engagement surface 20 oblique to or substantially perpendicular to the engagement surface 20 engaged by a first counter-engagement surface 50.

In certain embodiments, the object plate 40 may comprise a second shank receptacle hole 43 adapted to accept the second elongated shank 19. In certain embodiments, the second shank receptacle hole 43 may comprise one or more counter engagement surfaces analogous to those of the first shank receptacle hole 42 and similarly adapted to engage engagement surfaces 20 of the second elongated shank 19. Without limitation, in certain embodiments, the counter-engagement surfaces of the second shank receptacle hole 43 may be the surfaces defining the second shank receptacle hole 43 in the object plate 40. In certain embodiments the second shank receptacle hole 43 may be elongated or otherwise adapted to provide resistance to rotation of the second elongated shank 19 inserted therein. The second shank receptacle hole 43 may be formed in the object plate 40 by drilling, punching, stamping, cutting, casting, or other known forming processes.

In certain embodiments, a shank receptacle hole, such as, without limitation, the first shank receptacle hole 42, may comprise an engagement protrusion gap 44 adapted to permit insertion of one of the elongated shanks 18, 19 comprising an engagement protrusion 28. In certain embodiments, the object plate 40 comprises the shank receptacle hole 42 comprising engagement protrusion gap 44 and the second shank receptacle hole 43 not comprising engagement protrusion gap 44 in order to establish a substantially “mistake-proof” layout for the object plate 40 that creates substantial resistance to erroneous engagement of the wall bracket 10 with the object bracket 30, but which does not create substantial resistance to design engagement of the wall bracket 10 with the object bracket 30.

The support surface 60 may comprise adaptations to engage the object to be mounted 80. In certain embodiments, the support surface 60 is adapted to provide a vertical reaction force to support an object to be mounted 80 against vertical forces acting on the object to be mounted 80. Vertical forces acting on the object to be mounted 80 may include gravitational forces, dynamic or inertial forces from acceleration of an object to be mounted 80, or impact forces. A vertical reaction force may be produced in response to a force acting in any direction of action that includes a vertical component. In certain embodiments, the support surface 60 faces substantially upward and a vertical reaction force may act substantially upward. In certain embodiments, the support surface 60 is adapted to be sufficiently strong to provide enough upward support to support the object to be mounted 80 against downward forces without contribution from additional supporting elements. In embodiments in which the support surface 60 is adapted to be sufficiently strong to provide enough upward support to support the object to be mounted 80 against downward forces without contribution from additional supporting elements, the fasteners 8a or other components that act to secure support surface 60 to the object to be mounted 80 may be designed not to experience substantial downward forces or to provide substantial vertical reaction forces.

The capture surface 70 comprises adaptations to engage an object to be mounted 80. The capture surface 70 may have any facing with respect to the support surface 60, except the same facing as the support surface. That is, the capture surface 70 may be oblique to the support surface, substantially perpendicular to the support surface, or substantially opposed in facing to the support surface. In certain embodiments, the capture surface 70 is adapted to provide a horizontal reaction force to support the object to be mounted 80 against horizontal forces acting on an object to be mounted 80. Horizontal forces acting on the object to be mounted 80 may include dynamic or inertial forces from acceleration of the object to be mounted 80, or impact forces. A horizontal reaction force may have any direction of action that includes a horizontal component. In certain embodiments, a capture surface faces substantially opposite to the wall 6 and a horizontal reaction force from the capture surface will be substantially opposite to a horizontal reaction force from the wall 6.

In certain embodiments, the offset between capture surface 70 and surface 40b is adapted to be substantially similar to that of the thickness of the object to be mounted 80. The thickness of an object to be mounted 80 may vary between different objects to be mounted. In certain embodiments, selection of an object plate 40 having an offset substantially similar to that of the thickness of the object to be mounted 80 provides a fit between the wall 6 and the capture surface 70 that secures the object to be mounted 80 tightly. In certain embodiments, in order to allow selection of an object plate 40 having an offset substantially similar to that of the thickness of an object to be mounted 80, different object plates 40 may have differing offset between capture surface 70 and surface 40b.

In certain embodiments, and without limitation, the object plate may comprise an adjustable element that is adapted to make up, or adjust to, differences between the thickness of an object to be mounted 80 and the offset between capture surface 70 and surface 40b. In certain embodiments the adjustable element may comprise a set-screw, threaded clamp, shim-plate, spring, elastomeric pad, or similar element. In certain embodiments, the capture surface 70 comprises a female threaded aperture adapted to operationally engage with a male threaded adjustable element.

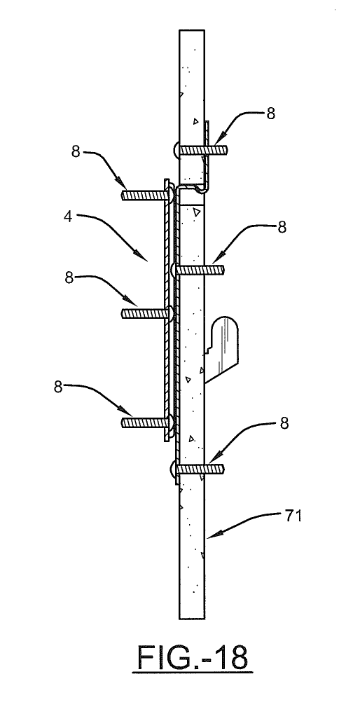

In certain embodiments, and without limitation, the object bracket 30 may comprise a single piece of material bent to form or differentiate the object plate 40, the support surface 60, and the capture surface 70. As used herein, unless otherwise noted, “integrally connected” components are components formed of the same single piece. Accordingly, in embodiments in which the object bracket 30 comprises the single piece of material bent to form or differentiate the object plate 40, the support surface 60, and the capture surface 70, the object plate 40, support surface 60, and capture surface 70 will be integrally connected. In certain embodiments, the object plate 40, support surface 60, and capture surface 70 are separated from one another by at least one bend. In certain embodiments, the support surface 60 and the capture surface 70 are separated from one another by a plurality of bends. Without limitation, as shown in FIG. 2, in certain embodiments, the bends separating the support surface 60 from the capture surface 70 are bent in opposite directions. Without limitation, opposing bends such as those shown separating the support surface 60 from the capture surface 70 in FIG. 2 may provide clearance for accommodating the object to be mounted, as shown in FIG. 18.

In certain embodiments, the object to be mounted 80 comprises surfaces adapted to engage surfaces of the object plate 40. In certain embodiments, the object to be mounted 80 comprises a first object surface 61 adapted to engage the support surface 60. In certain embodiments, the object to be mounted 80 comprises a second object surface 71 adapted to engage the capture surface 70. In certain embodiments, the object to be mounted 80 comprises a third object surface 81 adapted to engage the second object plate surface 40b.

In certain embodiments, the wall bracket 10 or the object bracket 30 may comprise a rib, flange, bend, ear, corrugation, strongback, or other strengthening protrusion 26.

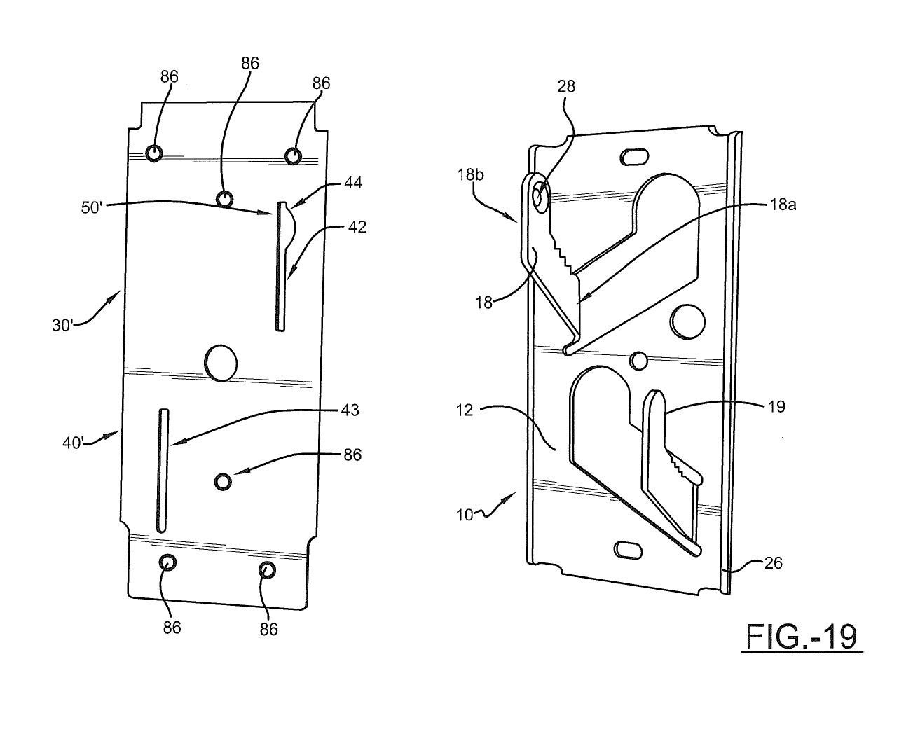

Another embodiment of the wall mount system 4 is shown in FIG. 19. In this embodiment, an object bracket 30 may comprise an object plate 40 and a first counter-engagement surface 50. The embodiment shown eliminates the support surface 60 and the capture surface 70 previously described. Because the object plate 30 is substantially planar, it is adapted to be closely engaged with a substantially flat object to be mounted, such as, without limitation, a backer board of a trophy head or trophy. A backer board may be of any of various thicknesses. The substantially planar object plate 40 can be engaged with backer boards of any thickness and thereby simplifies retro-fitting. That is, the object bracket 30 simplifies retro-fitting because the object bracket 30 is adapted to accommodate a backer board or other object to be mounted 80 of any thickness. As previously stated, the pattern of holes 86 accommodates mechanical fasteners 8 for engagement of the object bracket 30 with the object to be mounted 80.

In some embodiments, an object bracket 30 may comprise a feature to facilitate substantial horizontal displacement of the object bracket 30 with respect to a wall bracket 10 engaged therewith. As used herein, unless otherwise noted, a feature to facilitate substantial horizontal displacement of the object bracket 30 with respect to a wall bracket 10 engaged therewith will be referred to as a horizontal slip feature 32. Without limitation, a horizontal slip feature 32 may comprise, a hole having a substantial margin or clearance in the horizontal direction. In certain embodiments, and without limitation, a horizontal slip feature 32 of an object bracket 30 may comprise either a shank receptacle hole 42 or 43, oversized in the horizontal direction to provide substantial horizontal clearance for engagement of an elongated shank 18 or 19 therein.

Without limitation, in certain embodiments, a horizontal slip feature 32 may facilitate engagement of the object bracket 30 to the wall bracket 10, by providing additional clearance for insertion of an elongated shank 18 or 19 into a shank receptacle hole 42 or 43.

In some embodiments, a wall mount system 4 may comprise multiple wall brackets 10 and multiple object brackets 30. Without limitation, in some embodiments multiple pairs of wall brackets 10 and object brackets 30 are used to support the load from an object to be mounted 80 that is large, tall, wide, or heavy, with each pair of wall brackets 10 and object brackets 30 bearing some fraction of the total load needed to support the object to be mounted 80. In some embodiments, multiple wall brackets 10 are mounted to a wall 6 in a manner that displaces them from one another horizontally.

In certain embodiments in which multiple wall brackets 10 are mounted to a wall 6 in a manner that displaces them from one another horizontally, an object bracket 30 may comprise a horizontal slip feature 32. Without limitation, in some embodiments comprising multiple wall brackets 10, at least one object bracket 30 may lack a horizontal slip feature 32, such that a wall bracket 10 engaged therewith will be substantially fixed in the horizontal direction. Without limitation, in embodiments comprising multiple wall brackets 10, where the object to be mounted 80 and the object brackets 30 engaged therewith are substantially rigid, if at least one of the object brackets 30 lacks a horizontal slip feature 32 such that a wall bracket 10 engaged therewith will be substantially fixed in the horizontal direction, the entire assembly of the object to be mounted 80 and the object brackets 30 engaged therewith will also by substantially fixed in the horizontal direction. Without limitation, in certain embodiments comprising multiple wall brackets 10, where the object to be mounted 80 and the object brackets 30 engaged therewith are substantially rigid, one of the object brackets 30 lacks a horizontal slip feature 32, while other object brackets 30 comprise a horizontal slip feature 32.

In certain embodiments, and without limitation, the components comprising the wall mount system 4 may comprise E-coated surfaces, powder coated surfaces, zinc-plated surfaces, or combinations thereof.

While the wall mount system has been described above in connection with the certain embodiments, it is to be understood that other embodiments may be used or modifications and additions may be made to the described embodiments for performing the same function of the wall mount system without deviating therefrom. Further, the wall mount system may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the wall mount system. Therefore, the wall mount system should not be limited to any single embodiment, but rather construed in breadth and scope in accordance with the recitation of the attached claims.

What is claimed is:

1. A wall mount system, comprising:
a wall bracket comprising,
a wall plate,
a first elongated shank comprising an engagement surface adapted to support a first counter-engagement surface; and
an object bracket selectively connectable to said wall bracket, said object bracket comprising:
an object plate, said object plate comprising,
a first object plate surface; and
a second object plate surface facing opposite to and away from said first object plate surface,
a first through hole connecting said first object plate surface with said second object plate surface, said first through hole adapted to permit insertion of said first elongated shank into the first through hole,
a first counter-engagement surface integral to said object plate, and
a feature adapted to engage and support an associated object to be mounted.

2. The wall mounting system of claim 1, wherein the engagement surface of said first elongated shank comprises surfaces arranged in a stair-step or terrace-form.

3. The wall mounting system of claim 1, wherein
said first through hole comprises an interior surface of said first through hole, and
wherein said interior surface defines said first counter-engagement surface.

4. The wall mounting system of claim 3, wherein
said second object plate surface comprises a second counter-engagement surface.

5. The wall mounting system of claim 3, wherein said first elongated shank comprises: an engagement protrusion, and
said first through hole comprise an engagement protrusion gap adapted to permit insertion therethrough of said first elongated shank and said engagement protrusion.

6. The wall mounting system of claim 1, wherein
said object bracket comprises a formed single piece of material,
wherein said formed single piece of material comprising a first side and a second side, and
wherein said formed single piece of material comprises the object plate.

7. The wall mounting system of claim 1, wherein said wall plate comprises a first hole and a second hole.

8. The wall mounting system of claim 1, further comprising:
a support surface integrally connected to said object plate and adapted to support an associated object to be mounted, and
a capture surface integrally connected to said object plate.

9. The wall mounting system of claim 1, wherein said wall bracket further comprises:
a rib or flange integrally connected to said wall bracket.

10. The wall mounting system of claim 1, comprising high strength, low alloy steel having at least a 50 ksi yield strength.

11. A wall mount system, comprising:
a wall bracket comprising,
a wall plate, said wall plate comprising,
a first wall plate surface, and
a second wall plate surface facing substantially opposite to and away from said first wall plate surface, and
a first hole through said wall plate,
a first elongated shank comprising a first plurality of engagement surfaces adapted to engage a first counter-engagement surface and a second-counter engagement surface;
an object bracket selectively connectable to said wall bracket, said object bracket comprising,
an object plate, said object plate comprising,
a first object plate surface, and
a second object plate surface facing opposite to and away from said first object plate surface,
a first through hole connecting said first object plate surface with said second object plate surface, said first through hole adapted to permit insertion of said first elongated shank into the first through hole, said first through hole comprising, a first counter-engagement surface,
wherein said second object plate surface comprising a second counter-engagement surface,
a support surface integrally connected to said object plate and adapted to support an associated object to be mounted, and
a capture surface,
said capture surface integrally connected to said object plate, and
said capture surface facing substantially perpendicular to said support surface.

12. The wall mounting system of claim 11, wherein the first plurality of engagement surfaces are arranged in a stair-step or terrace-form.

13. The wall mounting system of claim 12, wherein said object bracket comprises:
a formed single piece of material,
said formed single piece of material comprising a first side and a second side;
said formed single piece of material comprises the object plate, the support surface, and the capture surface; and
said support surface is separated from said capture surface by a bend.

14. The wall mounting system of claim 13,
wherein said first through hole comprises an interior surface of said first through hole, and
wherein said interior surface defines said first counter-engagement surface.

15. The wall mounting system of claim 14,
wherein said capture surface faces substantially opposite to and toward said second object plate surface; and
wherein said support surface is substantially perpendicular to said second object plate surface.

16. The wall mounting system of claim 15, wherein said wall plate further comprises a second hole through said wall plate.

17. The wall mounting system of claim 16, further comprising:
a second elongated shank comprising a second plurality of engagement surfaces adapted to support a plurality of counter-engagement surfaces,
wherein the second plurality of engagement surfaces are arranged in a stair-step or terrace-form.

18. The wall mounting system of claim 17, wherein said object plate comprises:
a second through hole adapted to permit insertion of said second elongated shank into said second through hole,
said second through hole connecting said first object plate surface with said second object plate surface.

19. The wall mounting system of claim 18,
wherein said first elongated shank comprises an engagement protrusion, and
wherein said first through hole comprises an engagement protrusion gap adapted to permit insertion therethrough of said first elongated shank and said engagement protrusion.

20. The wall mounting system of claim 19, wherein said associated object to be mounted comprises:
a first object surface operatively connectable to said support surface;
a second object surface operatively connectable to said capture surface; and
a third object surface operatively connectable to said second object plate surface.

21. A wall mount system, comprising:
a steel wall bracket comprising,
a wall plate, said wall plate comprising,
a first wall plate surface, and
a second wall plate surface facing substantially opposite to and away from said first wall plate surface,
a first hole through said wall plate, and
a second hole through said wall plate,
a first elongated shank comprising,
a first plurality of engagement surfaces arranged in a stair-step or terrace-form, said first plurality of engagement surfaces adapted to engage a first counter-engagement surface and a second-counter engagement surface and an engagement protrusion, and
a strengthening protrusion, rib, or flange integrally connected to said wall bracket; and
a steel object bracket selectively connectable to said wall bracket, said object bracket comprising,
an object plate, said object plate comprising,
a first object plate surface, and
a second object plate surface facing opposite to and away from said first object plate surface, said second object plate surface comprising a second counter-engagement surface,
a first through hole adapted to permit insertion of said first elongated shank, said first through hole comprising,
a first counter-engagement surface, and
an engagement protrusion gap,
a support surface integrally connected to said object plate and adapted to support an associated object to be mounted, and
a capture surface,
said capture surface integrally connected to said object plate, and
said capture surface facing substantially perpendicular to said support surface; and
wherein said wall mount system is adapted to mount a trophy.

22. A method for mounting an object to be mounted, comprising:
providing a wall bracket, said wall bracket comprising
a wall plate, said wall plate comprising,
a first wall plate surface, and
a second wall plate surface facing substantially opposite to and away from said first wall plate surface, and
a first hole through said wall plate,
a first elongated shank comprising a first plurality of engagement surfaces adapted to engage a first counter-engagement surface and a second-counter engagement surface;
engaging said wall bracket with a wall;
providing an object bracket, said object bracket being selectively connectable to said wall bracket, said object bracket comprising,
an object plate, said object plate comprising,
a first object plate surface, and
a second object plate surface facing opposite to and away from said first object plate surface,
a first through hole connecting said first object plate surface with said second object plate surface, said first through hole adapted to permit insertion of said first elongated shank into the first through hole, said first through hole comprising, a first counter-engagement surface,
wherein said second object plate surface comprising a second counter-engagement surface,
a support surface integrally connected to said object plate and adapted to support an associated object to be mounted, and
a capture surface,
said capture surface integrally connected to said object plate, and
said capture surface facing substantially perpendicular to said support surface;
engaging said associated object to be mounted to said object bracket; and
engaging said object bracket with said wall bracket.
